(19) United States
(12) Patent Application Publication
(10) Pub. No.: US 2022/0305715 A1
(43) Pub. Date: Sep. 29, 2022

(54) A MICRO EMBOSSING UNIT WITH A BELT SYSTEM

(71) Applicant: PRNTSYS MAKINA VE AMBALAJ SANAYI TICARET LIMITED SIRKETI, Esenyurt, Istanbul (TR)

(72) Inventors: Ergin OZVURAL, Esenyurt, Istanbul (TR); Barbaros BAYDILLI, Esenyurt, Istanbul (TR)

(21) Appl. No.: 17/607,305

(22) PCT Filed: Sep. 8, 2020
(86) PCT No.: PCT/TR2020/050818

§ 371 Date: Oct. 28, 2021

(51) Int. Cl. B29C 63/02; B29C 63/00; B41F 23/04

(52) U.S. Cl. CPC B29C 63/02; B29C 63/0004; B41F 23/0476

(57) ABSTRACT

A cast and cure system which can be implemented by UV lacquer and which enables application of various patterns and sheathing on printed materials in areas such as flexible packaging, printing, serigraphy, label printing and offset tin printing. The system includes at least one UV cassette which enables the UV lacquer to pass under the UV light together with the belt and therefore curing the UV lacquer. The system relates to a micro embossing unit with belt-which has at least one cooler cylinder which cools the film coming out of the UV cassette, at least one cylinder which enables the film to be carried during the sheathing and at least one tension control system which automatically adjusts the tension of the cylinders.

### TECHNICAL FIELD

The invention generally relates to a printing machine which enables printing onto the raw materials such as film, metal and paper.

The invention specifically relates to a printing machine which has an infinite cycle system without the requirement of roll replacement. This invention relates to a separate printing machine which can perform the implementation to the raw material during the printing or after the printing as an equipment onto any of the units of the machines in all printing systems of layer to layer, bobbin to layer and roll to roll.

### STATE OF THE ART

Today, different types of printing methods are being performed on papers in printing sector and these have implementations in various areas. Implementations of these can be seen especially in areas such as flexible packaging, printing, serigraphy, label printing and offset tin printing.

In the implementations in the current printing technique, offset machines are being used in order to print onto paper. These machines can have different color items. For instance, they can be one color machines or machines with ten different colors. A single color is being printed in each of the units. Paper receives the respective color by passing over each unit and the ink is transferred onto the paper. Machines with multiple colors enable the printing of special colors as well as the main colors (blue, red, yellow and black). Printing a special pattern or model is performed by a cast and cure system in these machines. In order to be able to use cast and cure system, an equipment which will perform the implementation needs to be attached onto a unit of the printing machine. However, in this case, the number of units in the machine is decreased.

In cast and cure process, UV lacquer is applied in the first unit and lamination of the cast and cure process and drying under UV lamp steps are performed in the second unit. In the cast and cure application, it is needed that UV lacquer is printed partially or as a whole surface onto a paper and afterwards the cast and cure film is laminated onto the wet UV lacquer and these two are dried together by a special UV lamp which emits ultra-violate light.

Cast and cure film is a type of film with intrusions and protrusions in micro level and acts as a mold in the process. Cast and cure film is laminated onto the lacquer which is in wet state. Undried lacquer and the film which is laminated onto it together pass under the UV lamp in order to be dried. Afterwards, this film is peeled off the lacquer and is rolled onto the roller cylinder in the second unit. By this way, all patterns on the film are transferred onto the lacquer.

Another disadvantage of this implementation is that it is a high cost implementation due to film being sold in meter squares. In order to increase the efficiency of the machine, cast and cure film bobbins in the length of printing to be performed, in other words, bobbins long in meters, must be bought. This results in a significant cost. Film needs to be rolled very properly after the printing. In cases where there are wrinkles in the film, deformations in the patter occur, wrinkles are transferred to paper and the lifetime of the film is decreased. Therefore, a need of buying films more frequently might occur.

Another disadvantage of the current systems is that films that are used or films that are ordered to be used need to be restored in a clean environment. Since there will be a separate film for each pattern, a storing area and a place shall be arranged for each and all films. This storage area needs to be cleaned off of dust. Otherwise, dust fills in between the micro patterns of the cast and cure film and dusty film prevents a proper printing or results in a pattern being created in an undesired manner. While the film is being prepared for printing, it needs to be passed through units from unwinder to roller and connected to the roller, during which an adjustment loss is being created. At the end of the year, adjustment losses result in product loss in addition to financial loss as well as being an extra waste for the nature.

Another disadvantage of the current systems is their costs. For instance, a minimum amount of bobbin that needs to be purchased in bobbin systems is a bobbin of 5000 meters×1000 mm. When a meter square price for this bobbin is around 0.5 dollars, the cost of bobbin becomes 2500 dollars. In addition, when re-rolling of these bobbins is not performed in a clear and proper manner; a need of re-purchasing bobbins occur.

In the patent application with number TR 2012/00423 in the current state of art, a structuring substitute into a group of cylinders with the purpose of enabling an embossed printing onto paper in offset printing machines is mentioned. The invention is characterized by comprising a recess cylinder which has a soft layer on its outer surface and an embossing die which is structured between the said recess cylinder and the printing cylinder. The structuring mentioned in the invention does not provide solutions to the other problems in the current art.

In the European Patent application with number EP 2927010 in the current state of art, a printing technique using an offset printing press with perfect look formability is mentioned. The invention relates to a printing technique which uses multiple galettes for carrying a substrate, a cover located adjacent to the galette, a dry plate locate adjacent to the cover and an ink. The invention is characterized by comprising the method steps enabling the ink, which can be cured by UV, to be applied onto the substrate. The structuring mentioned in the invention does not provide solutions to the other problems in the current art.

As it is mentioned above, various problems and disadvantages are experienced in the relevant technical field and current applications are insufficient to solve these problems and disadvantages. As a consequence, a development and innovation is required in the technical field of the printing machines.

### AIM OF THE INVENTION

The present invention relates to a printing machine which fulfills the needs mentioned above, eliminates all the disadvantages and provides some additional advantages.

The main aim of the invention is to provide a printing machine with an infinite belt system which does not require replacement of bobbins by stopping the printing machine.

An aim of the invention is to develop a machine enabling adding two ends of the film to each other by correspondence and combining these two ends.

Another aim of the invention is to provide a printing machine with a structure to prevent leakage of the light in the UV cassette system.

Another aim of the invention is to provide a printing machine which prevents the light to leak by enabling upwards-downwards movement of the protective caps, which are located in the UV cassette system and prevent the light to leak, during the attachment of the belt.

Another aim of the invention is to provide a printing machine which does not require a storage or clean area to store the bobbins.

Another aim of the invention is to provide a printing machine with a decreased printing cost and which aims minimum loss during operation.

Another aim of the invention is to contribute to the zero waste aim by having a much lower amount of waste compared to the prior systems.

In order to provide all the advantages mentioned above and will be understood from the detailed description provided below, the present invention is a machine system which can be used in areas such as flexible packaging, printing, serigraphy, label printing and offset tin printing and which enables application of various patterns and sheathing on the print materials, and which comprises in a cast and cure system implemented by UV lacquer;
at least one UV cassette enabling the curing by UV beam,
a cooler cylinder which enables the cooling of the film which heats while it passes under the UV lamp,
at least one cylinder enabling the film to be carried during the sheathing,
at least one control system which adjusts the tension of the said cylinders automatically, characterized by comprising;
at least one belt which is created by adding the film end to end and which forms the infinite cycle system,
at least one rack-work which enables the belt to be attached by enabling the caps, which are located on the said UV cassette and prevent the light to leak outside, open and close.

The structural and characteristic features and all advantages of the invention will be understood more clearly through the detailed explanation written with the following figures and references to these figures, and therefore assessment should be made by considering these figures and detailed explanation.

### BRIEF DESCRIPTION OF DRAWINGS

In order for the structuring of the present invention and its advantages as well as its extra components to be understood in the best manner, an evaluation shall be made by taking the figures which are described below into the account.

FIG. 1 is a side view of the micro embossing unit with belt of the invention.

FIG. 2 is a top view of the extra apparatus of the invention.

FIG. 3 is a side view of the printing machine used in prior art.

### DESCRIPTION OF REFERENCES

1. Micro embossing unit with belt
2. Belt
3. Tension control system
4. UV cassette
5. Rack-work with protective cap
6. Cooler cylinder
7. Cylinder
8. Belt system unit
9. Protective cap
10. Extra apparatus

### REFERENCE NUMBERS IN PRIOR ART

100. Unwinder unit
101. Roller unit
102. UV cassette
103. Cooler cylinder
104. Cylinder

### DETAILED DESCRIPTION OF THE INVENTION

In the herein detailed description, the preferred configurations of micro embossing unit with belt (1) of the invention are described only for a better understanding of the subject matter, without posing any limitations.

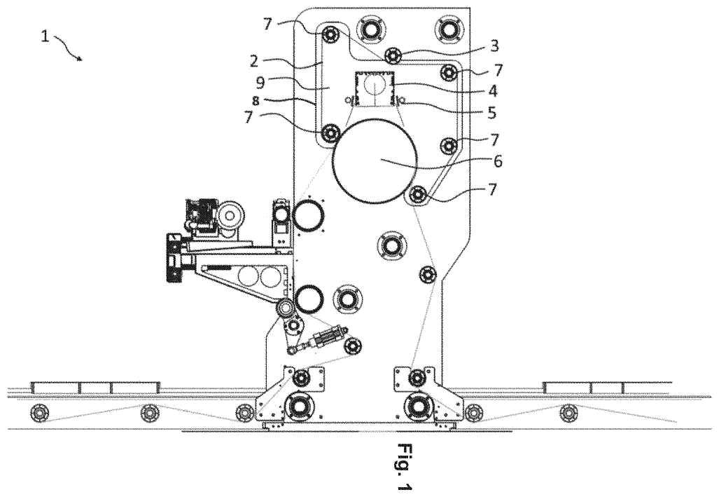

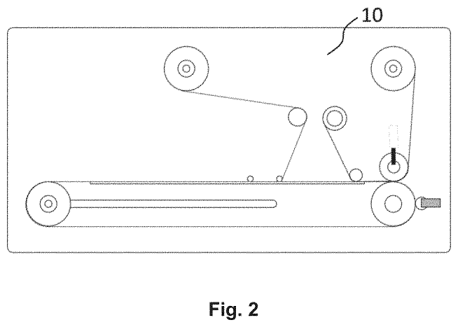

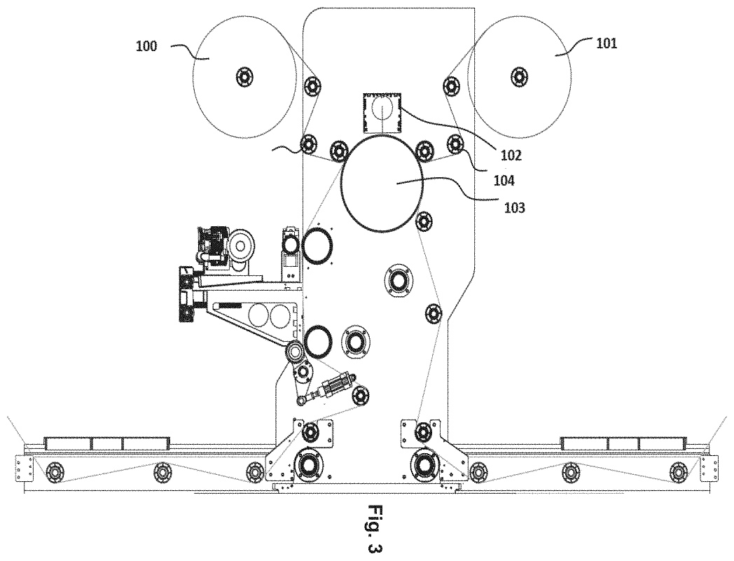

FIG. 1 shows a side view of the micro embossing unit with belt (1) of the invention. FIG. 2 shows a top view of the extra apparatus (10) of the invention. FIG. 3 shows a side view of the printing machine used in prior art.

The unwinder unit (100) which is included in the printing machine structure used in prior art, shown in FIG. 3, opens and feeds the patterned film which will be sheathed onto paper. The UV lacquer in the sheathed paper structure which passes through UV cassette (102) is cured by the UV light. The cured UV lacquer is cooled by passing through the cooler cylinder (103) and the process is completed by carrying it by the cylinders (104). The film which comes from the unwinder unit (100) and of which the patterns are put into the lacquer is rolled onto the cylinder in the roller unit (101) again. In this system, cost per meter square is significantly high. In addition, the necessity of storing the used films in a clean environment creates an additional burden.

The belt (2) used in the micro embossing unit with belt (1) of the invention shown in FIG. 1 is the cast and cure film which is used in prior art. This film is attached to the extra apparatus (10) as a bobbin. There is an extra apparatus (10) on the said apparatus which enables combining two ends. This unit automatically enables adding and combining two cut ends of the film by corresponding to each other. As a result of this process, belt (2) is created. This belt (2) is attached onto the belt system unit (8) in the micro embossing unit with belt (1) with infinite cycle system. The said belt system unit (8) is composed of cylinders. There is a tension control system (3) which automatically adjusts the tension of the belt (2) and is composed of cylinders. The said tension control system (3) is preferably a pneumatic tensioning system. The belt (2) provides infinite cycling by being attached onto the cylinders (7).

UV lacquer which passes under the UV light together with the film is cured. The belt (2) which comes out of the UV cassette (4) is cooled by passing through the cooler cylinder (6) and the process is completed by transferring the pattern on the film onto the cured UV lacquer.

There is a rack-work with protective cap (5) in order to prevent the leakage of light from the sides of the UV cassette (4) system. There are protective caps (9) which protect the whole system against dust and light. The rack-work with protective cap (5) can be moved upwards and downwards in order for the belt (2) to be attached. During the attachment of the belt (2), the rack-work with protective cap (5) is moved upwards and the belt (2) is attached. After the belt (2) is attached, the rack-work with protective cap (5) is moved downwards and therefore it prevents the belt from operating and the light from leaking.

1. A micro embossing unit with belt which can be used in areas such as flexible packaging, printing, serigraphy, label printing and offset tin printing and which enables application of various patterns and sheathing on the print materials, and which comprises in a cast and cure system implemented by UV lacquer;
at least one UV cassette enabling the curing the UV lacquer which is pressed under the cast and cure system by a UV beam,
at least one cooler cylinder which enables the cooling of film which comes out of the UV cassette,
at least one cylinder enabling the film to be carried during the sheathing,
at least one control system which adjusts the tension of the said cylinders automatically,
characterized by comprising;
at least one belt which is created by adding the film end to end and which forms the infinite cycle system,
at least one rack-work with a protective cap which enables the belt to be attached by enabling the caps, which are located on the said UV cassette and prevent the light to leak outside, open and close.

2. The micro embossing unit with belt according to claim 1, comprising at least one extra apparatus which forms the belt system and enables the two ends to be united.

3. The micro embossing unit with belt according to claim 1, comprising a tension control system with a pneumatic tensioning system composed of the cylinders which automatically arrange the tension of the belt.
